(19) United States
(12) Patent Application Publication
(10) Pub. No.: US 2026/0303597 A1
(43) Pub. Date: Oct. 1, 2026

(54) HIGH-THROUGHPUT PROXY-BASED ACCESS TO EVENT STREAMING PLATFORMS

(71) Applicant: Rivian IP Holdings, LLC, Irvine, CA (US)

(72) Inventors: Anirban KUNDU, Fremont, CA (US); Manoj NAIR, Cupertino, CA (US); Rupesh MORE, Fremont, CA (US)

(21) Appl. No.: 19/096,521

(22) Filed: Mar. 31, 2025

(51) Int. Cl. H04L 9/40; G06F 9/54

(52) U.S. Cl. CPC H04L 63/0884; G06F 9/546; G06F 9/547

(57) ABSTRACT

Aspects of the subject disclosure relate to high-throughput proxy-based access to event streaming platforms. Some examples of the disclosed proxy-based access can provide bidirectional stateful consumers with the ability to use remote procedure calls (RPC) to subscribe to and receive messages from cloud-based event streaming platforms. A client device may establish a persistent connection to a proxy server after authentication and authorization. The client device may use a native connection protocol for publish and/or subscribe, and/or may use RPC and/or channels to send messages to the proxy server. The proxy server may proxy a connection from the client device to a cloud-based event streaming platform, perform connection management for streaming services hosted in private subnets, and/or send messages bidirectionally when messages are available on either side of the proxied connection.

### INTRODUCTION

The present description relates generally to network-based communications, including, for example, to high-throughput proxy-based access to event streaming platforms.

### SUMMARY

Aspects of the present disclosure relate to systems and methods for providing high throughput publish and subscribe for messages relating to vehicles. For example, a fleet manager may subscribe to messages corresponding to state information for a fleet of vehicles. The disclosed systems and methods provide for message delivery guarantee, failure handling on a remote client, standard authentication and authorization support, message compression, flow control, and error handling and debugging.

In accordance with aspects of the subject technology, a method is disclosed that includes maintaining, by a server, a pool of connections to a cloud-based stream-processing service; establishing, while maintaining the pool of connections, a client connection with a client device; receiving, while maintaining the pool of connections and via the client connection, subscription information for the client device; obtaining a consumer connection from the pool of connections; obtaining, via the consumer connection, a message associated with the subscription information from the cloud-based stream-processing service; generating, by the server, a remote procedure call (RPC) message based on the message; and providing, via the client connection, the RPC message to the client device.

The subscription information may include a topic, and wherein the message is associated with the topic. The subscription information may also include an additional topic, and the method may also include: obtaining, via the consumer connection, an additional message associated with the additional topic from the cloud-based stream-processing service; generating, by the server, an additional RPC message based on the additional message; and providing, via the client connection, the additional RPC message to the client device.

The subscription information may include a request to receive messages at least once, and the method may also include redelivering the RPC message responsive to an error indication from the client device. The method may also include, by the server: identifying a communication error; and providing an indicator of the communication error to the client device. The subscription information may include a request to automatically acknowledge messages. The subscription information may include a request to explicitly acknowledge messages.

The method may also include performing, by the server and prior to maintaining the pool of connections, performing an authentication operation with the cloud-based stream-processing service; establishing, by the server, the pool of connections upon completion of the authentication operation; and performing, by the server and prior to establishing the client connection, an additional authentication operation with the client device. Obtaining the message associated with the subscription information from the cloud-based stream-processing service comprises obtaining the message without performing a further additional authentication operation for the message or the RPC message. The client device may be associated with a fleet manager for a fleet of vehicles, and the message may include information associated with at least one vehicle of the fleet of vehicles.

In accordance with aspects of the subject technology, a server is disclosed that is configured to: maintain a pool of connections to a cloud-based stream-processing service; establish, while maintaining the pool of connections, a client connection with a client device; obtain a producer connection from the pool of connections; receive, while maintaining the pool of connections and via the client connection, a remote procedure call (RPC) message from the client device; generate, based on the RPC message and service information for the cloud-based stream-processing service, a modified message; and provide, via the producer connection, the modified message to the cloud-based stream-processing service for distribution to one or more subscribers from the cloud-based stream-processing service.

The server may be further configured to, prior to maintaining the pool of connections, perform an authentication operation with the cloud-based stream-processing service, and establish the pool of connections upon completion of the authentication operation.

The server may be further configured to perform an additional authentication operation with the client device. The server may be further configured to provide the modified message to the cloud-based stream-processing service without performing an authentication operation for the message or the modified message. The service information may include protocol information for communication with the cloud-based stream-processing service. The server may be further configured to provide the modified message to the cloud-based stream-processing service by writing the modified message and a header map to a partition of the cloud-based stream-processing service, the partition corresponding to a topic indicated in the RPC message.

The server may be further configured to receive, while maintaining the pool of connections and via the client connection, an additional RPC message from the client device; and write an additional modified message and an additional header map to another partition of the cloud-based stream-processing service, the other partition corresponding to another topic indicated in the additional RPC message. The server may be further configured to generate the header map responsive to receiving the RPC message. The server may be further configured to generate the modified message at least in part by deserializing the RPC message.

The server may be further configured to: receive a cancel request from the client device; and return the producer connection to the pool of connection maintained by the server.

The server may be further configured to establish, while maintaining the pool of connections, an additional client connection with an additional client device; receive, from the cloud-based stream-processing service, an additional message; convert the additional message from to an additional RPC message using the service information; and provide the additional RPC message to the additional client device via the client additional connection. The RPC message may be associated with at least one vehicle.

In accordance with other aspects of the disclosure, a proxy server is disclosed that is configured to maintain a pool of connections to a cloud-based stream-processing service; establish, while maintaining the pool of connections, a client connection with a client device; receive, while maintaining the pool of connections and via the client connection, subscription information for the client device; obtain a consumer connection from the pool of connections; obtain, via the consumer connection, a message associated with the subscription information from the cloud-based stream-processing service; generate a remote procedure call (RPC) message based on the message; and provide, via the client connection, the RPC message to the client device.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic diagrams of example implementations of a network environment that includes a vehicle in accordance with one or more implementations.

FIG. 2 illustrates a schematic view of a publish operation via a proxy server in accordance with one or more implementations.

FIG. 3 illustrates a schematic view of a subscribe operation via a proxy server in accordance with one or more implementations.

FIG. 4 illustrates a schematic view of a subscribe operation using multiple partitions via a proxy server in accordance with one or more implementations.

FIG. 5 illustrates a schematic view of a subscribe operation using explicit acknowledgements via a proxy server in accordance with one or more implementations.

FIG. 6 is a flow chart of illustrative operations that may be performed by a proxy server for a subscribe operation in accordance with one or more implementations.

FIG. 7 is a flow chart of illustrative operations that may be performed by a proxy server for a publish operation in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Vehicles have historically been standalone machines that do not communicate without outside systems. Even as some vehicle operations have become computerized, connectivity with outside systems has typically been limited to physically connecting a vehicle to a diagnosis system at a mechanic, or passthrough connections that provide cellular telephone or street-map services to a driver through a vehicle speaker or display screen.

More recently, vehicles may be provided with communications circuitry, and may communicate (e.g., periodically, occasionally, or persistently) with one or more remote services, such as servers and/or cloud-based services. For example, individual vehicles and/or groups of vehicles (e.g., fleets of vehicles) can provide, to one or more servers (e.g., servers associated with a manufacturer of the vehicle(s)) information about the vehicle's current and past locations, the vehicle's navigation routes, the vehicle's operating speeds, the vehicle's inertial data (e.g., acceleration data, deceleration data, impact data, and/or the like), sensor data that indicates the status of one or more components (e.g., tires, brake pads, connectors, locks, mechanical components, electrical components), battery charge information, battery cycle information, component life information, and/or other information about the status, location, and/or state of the vehicle.

This information may be received from many (e.g., hundreds, thousands, hundreds of thousands, or millions) of vehicles, such as at one or more servers (e.g., one or more servers associated with, or owned by, a manufacturer of the vehicles). Various entities (e.g., fleet managers, insurance providers, etc.) may be interested in receiving and/or consuming this information from the one or more servers.

Aspects of the subject technology may provide various consumer devices with the ability use one or more event streaming services to receive high-throughput vehicle data via a proxy service. Further details are provided hereinafter.

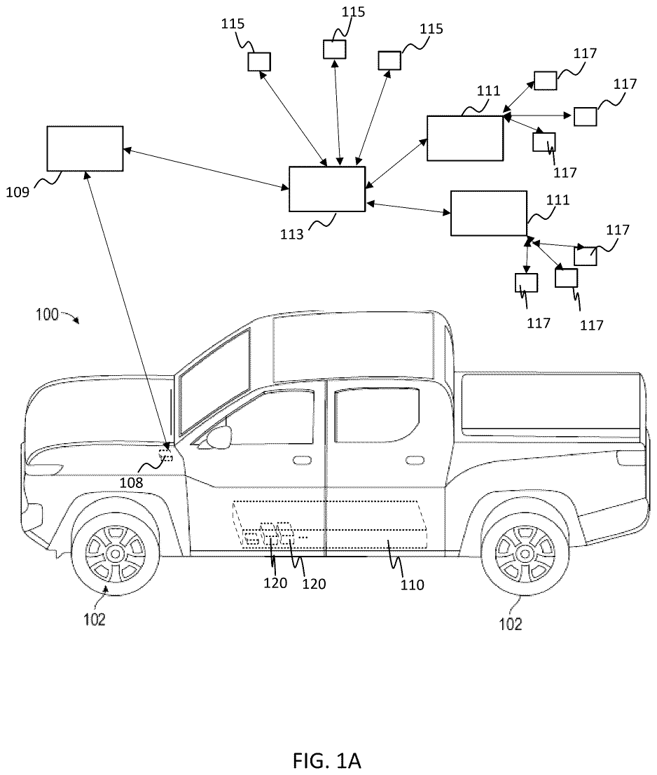

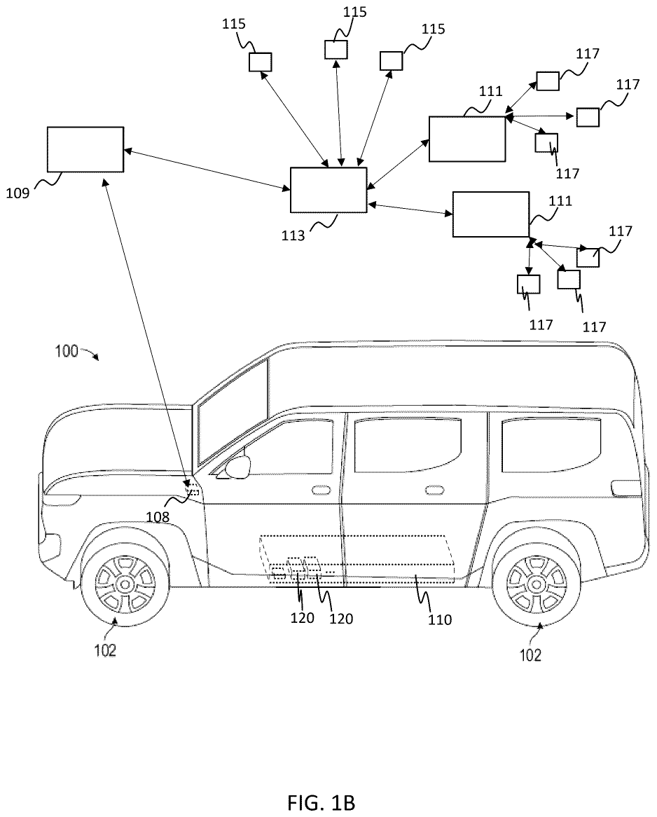

FIG. 1A is a diagram illustrating an example implementation of a system as described herein. In the example of FIG. 1A, the system includes an apparatus (e.g., a moveable apparatus) implemented as a vehicle 100. The vehicle 100 may be implemented as an electric vehicle and may include one or more batteries 110 for powering the vehicle and/or one or more systems and/or components of the vehicle. As shown, the battery 110 may include one or more battery cells 120.

For example, the vehicle 100 may be an electric vehicle having one or more electric motors that drive the wheels 102 of the vehicle using electric power from the battery 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having one or more batteries 110 (e.g., a battery pack in which multiple, such as hundreds or thousands of battery cells are disposed), and circuitry 108 (e.g., including one or more processors, memory, and/or communications circuitry).

As examples, the circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). The circuitry 108 may include input devices, output devices, network interfaces, and/or a bus that communicatively couples the processor(s), the memory, the communications circuitry, the input devices, the output devices, and/or one or more other devices or components (e.g., motion sensors, proximity sensors, etc.). The processor(s) of the circuitry 108 may execute instructions stored in the memory of the circuitry 108, such as to execute one or more machine learning models (e.g., neural networks, such as deep learning networks, transformer-based models and/or other attention-based models, multi-layer perceptrons or other feed-forward networks) and/or other hardware, firmware, and/or software processes in order to perform the processes of the subject disclosure.

In one or more implementations, one or more processors of the circuitry 108 may be configured to operate communications circuitry (e.g., WiFi circuitry, cellular communications circuitry, and/or other communications circuitry) of the circuitry 108 for communication with one or more remote systems. For example, as shown in FIG. 1A, the vehicle 100 may communicate vehicle data to one or more servers, such as a server 109. Although a single server 109 is shown, the server 109 may represent multiple servers in some implementations. Server 109 represent on or more servers of (e.g., owned by, managed by) a manufacturer of the vehicle 100 and/or one or more other vehicles. The server 109 may accumulate (e.g., receive and store) vehicle data for the vehicle 100 and/or one or more other vehicles (e.g., two vehicles, more than two vehicle, tens of vehicles, thousands of vehicles, tens of thousands of vehicles, hundreds of thousands of vehicles, or millions of vehicles).

In one or more implementations, cloud-based services 111 may include event streaming services that distribute data (e.g., in the form of messages) to one or more consumer devices 117. Examples of event streaming services include Amazon Kinesis®, Apache Kakfa®, Redpanda®, and Neural Autonomic Transport System (NATS). For examples, cloud-based services 111 may provide consumer devices 117 with the ability to subscribe to one or more topics, and to receive streaming messages that are published to those one or more topics by producer devices. For example, the consumer devices 117 may be devices that are associated with the cloud-based services 111 (e.g., provided by the same provider as the provider of the cloud-based services 111), and/or may be external devices that communicate with the cloud-based services 111 via application programming interface (API), such a secure hypertext transfer protocol (e.g., https) API interface. However, there can be several drawbacks to an https interface with the cloud-based services 111, for both producers and consumers of event streaming messages.

For example, while a public facing API gateway can be used to access a cloud-based service 111 by converting client messages to a protocol of the cloud-based service 111, this forces clients to communicate with the API Gateway using https. Using https may reduce development costs for producers and consumers, but may also introduce significant overhead with authentication, authorization, handshake costs, message transformation, etc. For a high throughput publisher, this may not be efficient, and may cause back-pressure. Even if an API gateway can potentially handle thousands of concurrent threads, the API gateway-managed connections, or using an intermediary (e.g., VPCLink), will have overheads that reduce the throughput. Https threads also do not guarantee ordering of messages, if some of the messages are delivered concurrently.

One approach to address these issues with an https interface is to increase the number of partitions, but partitions do not have any influence for producers. An https interface also offers no hooks for services to validate messages before delivering to cloud-based services 111 topics. Clients may deliver bad messages and not be aware until consumers eventually consume and reject such messages.

The challenge with this approach for consumers may be even greater, and not straightforward. One other approach to improving https interfaces is to create a service or a middleware (e.g., a VPC service) that acts as a cloud-based services consumer and then exposes an GET API (e.g., HTTP/REST) that can be invoked via the API gateway. However, this other approach has the same downsides of the above-mentioned producer overheads. Additionally, this other approach can (a) fall behind with increasing consumer lag for a high throughput topic, and/or (b) waste client and API gateway CPU cycles by continuously polling for topics that have infrequent messages.

A second other approach to improving https interfaces is to register a callback with the middleware service and let that service call the client's destination to deliver messages when available in a topic. This reduces the waste for polling but requires the client to setup a highly scalable public service for accepting messages. The operations of authentication, authorization and handshake overhead remain. This also introduces a life-cycle management in which a client registers a webhook/callback API with a middleware service (behind API Gateway), the client sends a message to start the middleware service to publish, the middleware service starts to consume from a topic and invokes client's public API Service, and then the client sends a message to stop the middleware service from publishing. This second other approach to improving an https interface to cloud-based services 111 may be an improvement with the utilization of middleware service (e.g., as this can be shared infrastructure) and without the performance connection management, if a client is not ready to consume.

However, even in these improved https interfaces, given consumers of most event streaming services are limited by the number of partitions/shards for given topic, both poll-based (e.g., client pulls) solutions and push-based (e.g., callback) solutions would limit throughput as determined by overheads on the terminating side. In either case, the assumption is that consumers are durable and an API Gateway will provide an interface that lets consumers define a consumer name. This also creates challenges, particularly if consumers want to “replay from earliest” or from a point-in-time. With respect to performance, all of the above approaches assume https as the underlying protocol for delivering messages securely. Accordingly, all of the above approaches include significant overhead in SSL handshakes for every message delivered in this manner—resulting in wasted compute on client. In some business-to-business (B2B) systems, clients may use a mutual transport layer security (mTLS), which incurs an additional authentication on server—for validating the client's X509 certificate issuer is trusted as per the server's truststore certificate authority (CA).

In accordance with one or more implementations of the subject technology, one or more servers, such as a server 113 (e.g., a proxy server) may provide an interface between client devices (e.g., one or more producer devices, such as the server 109, and/or one or more consumer services, such as consumer devices 115) and the cloud-based services 111. In this way, the server 113 may provide a connected system for the server 109, the consumer devices 115, and the cloud-based services 111. For example, in a connected system, a client may make an attempt to establish a persistent connection after authentication and authorization, a client may use a native connection protocol for publish/subscribe or RPC or use of channels to send messages to intermediate cloud-based proxy service, and the cloud-based proxy service (e.g., server 113) proxies a connection from the client, performs connection management for streaming services hosted in one or more private subnets, and sends messages bidirectionally when messages are available on either side. Although a single server 113 is shown, the server 113 may represent multiple servers in some implementations.

For example, in one or more use cases, the server 109 may act as a producer that provides vehicle data (e.g., in the form of messages) to one or more consumer devices 115 via the server(s) 113 and the cloud-based services 111. For example, the consumer devices 115 may interface with the server 113 to subscribe to one or more topics managed by the cloud-based services 111. The server 109 may interface with the server(s) 113 to publish the vehicle data to the one or more topics managed by the cloud-based services 111. The server 113 may maintain one or more secure, authenticated connections with the cloud-based services 111 and may also establish secure, authenticated connections with client devices. With these connections the server 113 can facilitate the exchange of messages between the client devices and the cloud-based services, without performing per-message authentication operations. Providing the server 113 as a proxy server in this way avoids the bidirectional SSL handshake overheads described in connection with the https interface approaches above, and offers a secure, encrypted mechanism of delivering high throughput messages.

In various examples discussed herein, the server 113 may be referred to interchangeably as a “proxy service”, a “proxy server”, a “proxy”, or a “cloud proxy”. In one or more implementations, remote procedure call (RPC, such as gRPC) protocols may be used for messages between client devices (e.g., server 109 and/or consumer devices 115) and the cloud proxy, and the cloud proxy (e.g., server 113) manages connections, failure and recovery, subscription acknowledgement, and/or other communications/interactions to and/or with a backend messaging service (e.g., a cloud-based services 111).

As discussed in further detail hereinafter, the proxy service provided by the server 113 between the client devices and the cloud-based services 111 may provide various benefits, including high throughput publish and subscribe, message delivery guarantee, failure handling on remote, standard authentication and authorization support, message compression, flow control, and error handling, debugging and metrics.

For example, with respect to high throughput publish and subscribe, the proxy service may provide for a throughput of millions of messages in under a few (e.g., less than ten) minutes, in contrast with several hours for the same number of messages with an https interface. For example, the request rate for publishers may be determined and limited by a client's ability to publish messages. Multiple publishers can be instantiated using a same “tenant” identifier and/or credentials, thereby increasing concurrency and throughput. The cloud proxy may perform additional transformation, connection management, error recovery etc. As discussed in further detail hereinafter, the server 113 may provision, from the cloud-based services 111, a shared connection pool. Scaling may be provided by provisioning, by the server 113 from the cloud-based services 111, a shared connection pool capacity that is sufficient for both publishing and subscription (e.g., using Kafka and/or KafkaConnection) and a sufficient number of shards or partitions in the messaging service.

For subscribers, the server 113 may provide (i) end-to-end (e2e) support for a durable subscription with clients acknowledging receipt of each message (e.g., or support may be provided and offsets may be tracked in a cloud-based services cluster), and the server 113 may provide (ii) tolerance to lost messages, with the proxy service acknowledging the message to the cloud-based service 111 (e.g., offset moved) and the proxy service attempting to best-effort deliver the message to the client. Feature (ii) above may be as much as, or more than, twice as efficient as existing systems (e.g., if message loss is acceptable due to infrequent network breaks when delivering acknowledged messages from the cloud-proxy to a client).

For example, with respect to message delivery guarantee, the server 113 may support guaranteed delivery of messages. For example, the server 113 may provide options including “exactly once” delivery and/or “at-least once” (e.g., and/or “at-most once” in some implementations). The server 113 may facilitate client devices (e.g., consumer devices 115) explicitly acknowledging receipt of a message in some use cases. In other use cases, a client (e.g., a client that does not manage ack complexity) may allow the cloud-proxy to manage acknowledgment on the client's behalf, such as based on client requested ack options. For “at least once” delivery, duplicates may be handled by client devices (e.g., by debouncing). For subscription, for messages that are read and acknowledged from the messaging service and are not delivered (e.g., due to channel interruption), in-flight messages may be dumped into an error queue for analysis and/or replay.

For example, with respect to failure handling on remote clients, the server 113 may allow client devices to retry and recover connection establishing in case of drops, and/or message publish or subscribe in cases of RPC general or protocol errors. For example, a client may no longer be interested in the result of an RPC call and may cancel, to signal discontinuation of interest to server 113. The server 113 may use this signal to reallocate (e.g., connection) resources that are currently dedicated to disconnecting clients.

For example, with respect to standard authentication and authorization support, the server 113 may leverage rights in, for example, token-based (e.g., JSON Web Token (JWT)) and/or certificate-based checking of privileges. For example, certificates, such as X509-based certs, may may be used that contain common name (CN) or issuer identifiers to indicate rights granted to a client. JWT-based authentication may be used to enforce rights checking by custom identity providers. These permissions can be mapped in the proxy service (e.g., server 113) to low-level publish and consume access control list (ACL) permissions.

For example, a CN in an X509 cert, or a user_id in a JWT token may be mapped, by the server 113, to static rights. The proxy service (e.g., server 113) may enforce connection modes (e.g., explicit or automatic acknowledgment modes) and/or message formats e.g., (JSON, text, binary, etc.). Topic permissions may be set using explicit mentions (e.g., a blank permission entry may indicate that no permission is provided for a particular client).

For example, with respect to message compression, the server 113 may provide for protocol buffer (protobuf) serialization tooling in one or more implementations. For example, both producers and subscribers may use predefined protobuf bindings to create an envelope and wrap a (e.g., base64 encoded byte[ ]) message payload. Both producers and consumers may utilize a batch type, such as a VlfMessageBatch type, and may be capable of serializing and deserializing the payload. The nested payload may be a custom-defined protobuf message or may use an existing format, such as a JSON ascii blob.

For example, with respect to flow control, for subscription, clients may be provided with the ability to dictate a rate of messages by requesting, from the server 113, an explicit acknowledgment of each message before a next message is sent. The server 113 may also provide client with the ability to consume messages from one or more specific partitions or from a range of partitions (m-n) (e.g., by specifying the partitions to the server 113). This allows clients to instantiate maximum number, n, of threads, where each thread can read messages from one of the n partitions for a topic.

In one or more implementations, the server 113 may provide the ability to override default behavior with explicit controls, beyond default handling, of interactions between stubs and skeletons, and management of flow control.

For example, with respect to error handling, the server 113 may indicate RPC failures to relevant client devices using, for example, RPC error codes (e.g., error codes for errors such as: a client application cancelling a request, a deadline expiring before a server returns status, a method not found on the server, a server shutting down, and/or a server threw an exception or did something other than returning a status code to terminate the RPC). In addition, cloud-based services errors related to authentication and/or ACL permissions (e.g., topics, consumer groups) may be notified as general (e.g., status unknown) errors, and may be provided by the server 113 with custom error descriptions.

In one or more implementations, various aspects of the high throughput publish and subscribe, message delivery guarantee, failure handling on remote, standard authentication and authorization support, message compression, flow control, and error handling, debugging and metrics features described above may be controlled by the server 113 based on information stored at the server 113 for each client device. For example, the server 113 may store client names, identifiers, authentication modes, acknowledgement modes (e.g., explicit or automatic), permissions for publish and/or subscribe (e.g., including topic names, message types for specific topics), partition identifiers, and/or other information. The server 113 may also store protocol information for communications with the cloud-based services 111.

The example of FIG. 1A, in which the vehicles 100 that communicate their vehicle data (e.g., to the server 109) is implemented as a pickup truck having a truck bed, is merely illustrative. For example, FIG. 1B illustrates another implementation in which the vehicle 100 including the battery 110, and the circuitry 108 is implemented as a sport utility vehicle (SUV), such as an electric sport utility vehicle. In the example of FIG. 1B, the vehicle 100 including the battery 110, and the circuitry 108 may include a cargo storage area in at least a rear portion of the vehicle that is enclosed within the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having the circuitry 108. In one or more implementations, the battery 110, and the circuitry 108 as described herein may also, or alternatively, be implemented in another apparatus, such as a building (e.g., a residential home or commercial building, or any other building) or other stationary apparatus.

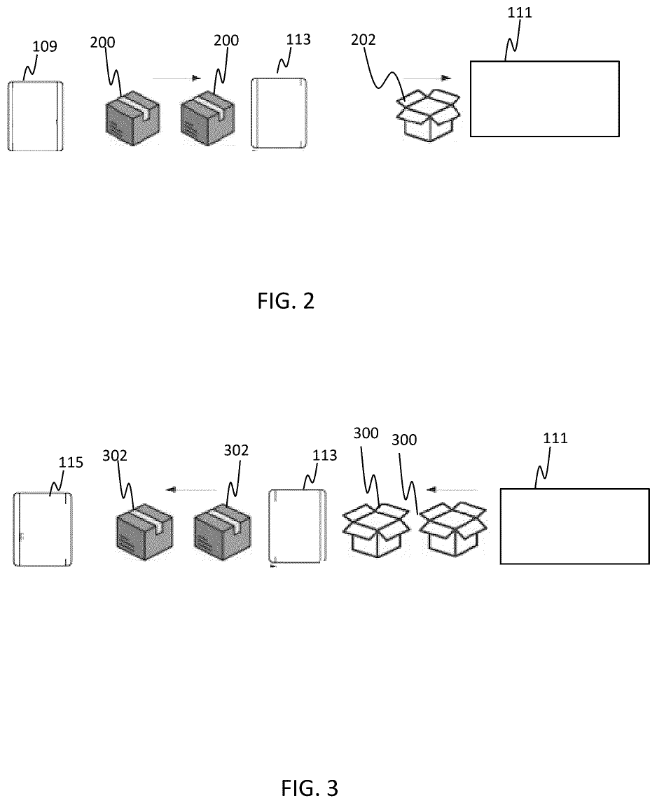

FIG. 2 depicts an example in which the server 113 (e.g., the proxy service) manages publication of messages from a client device (e.g., a client device acting as a producer or publisher, such as the server 109, in this example), and a cloud-based service 111 (e.g., an event streaming service). For example, the server 113 may separately maintain a pool of authenticated connections to the cloud-based service 111, prior to the client connecting to the server 113. The pool of connections may include connections configured, or configurable, as producer connections and/or connections configured, or configurable, as consumer connections. In the example of FIG. 2, the client (e.g., the server 109) may connect to the cloud proxy service (e.g., the server 113). The server 113 may perform an authentication and/or authorization of the client device. Authentication may include using mutual transport layer security (mTLS) in some implementations, such as with a certificate (e.g., an X509 cert) signed by an entity associated with the server 109 and/or the server 113. The service may support SASL/SCRAM authentication on behalf of the consumer. Authorization may be implemented using custom rights defined in, for example, JWT, or derived from, for example, a CN in X509 cert. Authorization protocols may match with the authorization rules discussed above.

Upon successful authentication and/or authorization of the client, the server 113 may obtain (e.g., fetch) a producer connection (e.g., a KafkaProducer, in the example of an Apache Kafka implementation of the cloud-based service 111) from the connection pool. The client may then publish messages 200 (e.g., protobuf message wrapping byte[ ] payload). The server 113 may consume the messages 200 in a loop from an RPC (e.g., gRPC) handler (e.g., using .Recv( )) (e.g., without performing additional authentication operations per message). The server 113 may process the messages 200 (e.g., by deserializing the messages 200 and/or preparing headers and/or header maps according to a protocol of the cloud-based service 111). The server 113 may then write processed messages 202 (e.g., including the deserialized message and a header map) to the cloud-based service 111 (e.g., to a particular partition, corresponding to a topic of the message, of the cloud-based service 111). The server 113 may write the processed messages 202 to the cloud-based service 111 without performing additional authentication operations per message. Once the client device is ready to terminate publication of messages, the client device may send a client cancel request to the server 113 (e.g., the proxy service). Responsive to receiving the client cancel request, the server 113 may return the producer connection to the pool.

FIG. 3 depicts an example in which the server 113 (e.g., the proxy service) manages subscriptions of a client device (e.g., a consumer device 115 in this example) to one or more topics managed by a cloud-based service 111 (e.g., an event streaming service). In the examples of FIGS. 2 and 3, the server 109 is depicted as a producer (publisher), and the consumer device 115 is depicted as a subscriber. In is appreciated that, in other examples, the server 109 may also, or alternatively, be a subscriber, and/or the consumer devices 115 may also, or alternatively, be producers. In the example of FIG. 2, the client (e.g., consumer device 115) may connect to the cloud proxy service (e.g., the server 113). The server 113 may perform an authentication and/or authorization of the client device.

Upon successful authentication and/or authorization of the client device, the server 113 may obtain (e.g., fetch or check out) a consumer connection (e.g., a KafkaConsumer, in the example of an Apache Kafka implementation of the cloud-based service 111) from the connection pool. Another client device may then publish messages 200 (e.g., protobuf message wrapping byte[ ] payload) as described in connection with FIG. 2. The server 113 may then read (e.g., without performing additional authentication operations per message) messages 300 (e.g., corresponding to messages 200 previously published by a producer, such as the server 109) from a topic at the cloud-based service 111 (e.g., from one or more partitions of the cloud-based service 111). For example, the messages 300 may be the same as, or similar to, the processed messages 202 written to the cloud-based service 111 in FIG. 2. The server 113 may process the messages 300 (e.g., by serializing the messages 300) to generate RPC messages 302. The server 113 may then send (e.g., without performing additional authentication operations per message) the RPC messages 302 to the client device (e.g., the consumer device 115). In the case of a message error, the server 113 may notify the client device of the error.

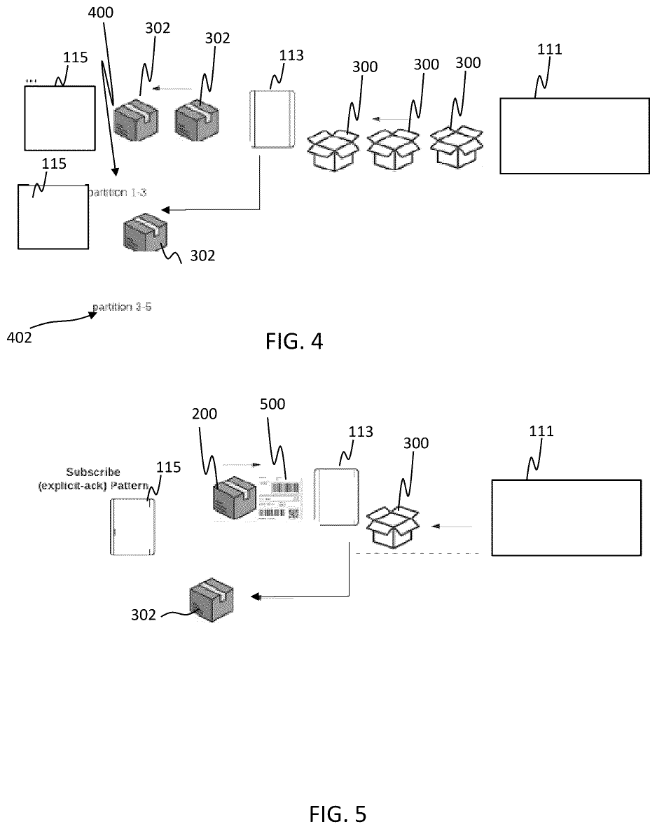

The example of FIG. 3 illustrates subscriptions for a single client device. FIG. 4 illustrates another example in which multiple consumer devices 115 subscribe to event streaming from the cloud-based service 111 via the server 113. In the example of FIG. 4, a first consumer device 115 receives messages 302 that are generated by the server 113 based on messages 300 (e.g., by processing the messages 300 to form the messages 302) from a first partition or set of partitions 400 (e.g., partitions 1-3), and a second consumer device 115 receives messages 302 that are generated by the server 113 based on messages 300 from a second partition or set of partitions 402(e.g., partitions 3-5). In some implementations, the first consumer device 115 may specify, to the server 113 prior to receiving the messages 302, a subscription to the first partition or set of partitions, and the second consumer device 115 may specify, to the server 113 prior to receiving the messages 302, a subscription to the second partition or set of partitions. The server 113 may then obtain the messages 300 from the relevant partition(s) for each consumer device 115. The server 113 facilitating the use of partitions in this way allows a higher throughput, in addition to the higher throughput achieved by removing per-message authentications. In one or more implementations, messages 300 and/or 302 may be partitioned by a partition key, allowing the client (e.g., consumer devices 115) to retain ordering of messages per partition.

The examples of FIGS. 3 and 4 may be performed for subscriptions for which the client devices have requested an automatic acknowledgement of the messages 300. In other use cases, a client device may request explicit acknowledgement of messages 300 before a next message 300 is delivered to the client. For example, FIG. 5 illustrates a use case in which a consumer device 115 provides a message 200 (e.g., an RPC message) with an acknowledgement receipt 500 to the server 113. The server 113 then obtains the next message 300 from the cloud-based service 111, processes the next message 300 to generate a next RPC message 302, and provides the next RPC message 302 to the consumer device 115.

In one or more implementations, a client device (e.g., the consumer device 115) may send a message 200 with an identifier that indicates a start of a subscription. The server 113 may then send a message to the client device (e.g., using a consumer poll). While such message has not been acknowledged, an offset in the cloud-based service 111 may not be moved until the acknowledgement receipt is received, indicating the message has been committed. Once the client processes the message, the client can send an acknowledgement receipt 500. The acknowledgement receipt 500 may indicate that the message was accepted (e.g., to indicate to move to the next message) or may request a redelivery of the message. In the case that the message acknowledgement is not received within an expiration time window, the message may be redelivered to another consumer.

The examples of FIGS. 2-5 may provide systems and methods for bidirectional stateful consumers using RPC for message brokers, such as event streaming services. In one or more implementations, the server 113 may also provide an https interface that allows https clients (e.g., clients that have not developed RPC capabilities for communication with the server 113) to still publish and subscribe using the cloud-based services 111. Https clients may be stateless. For example, for non-RPC clients, the proxy service allows streaming of https server-side events (SSE) by responding with headers. Rules for mTLS authentication and/or authorization may be enforced for https clients similarly to the authentication and/or authorization described above for RPC clients, however https messages may undergo authentication operations per message.

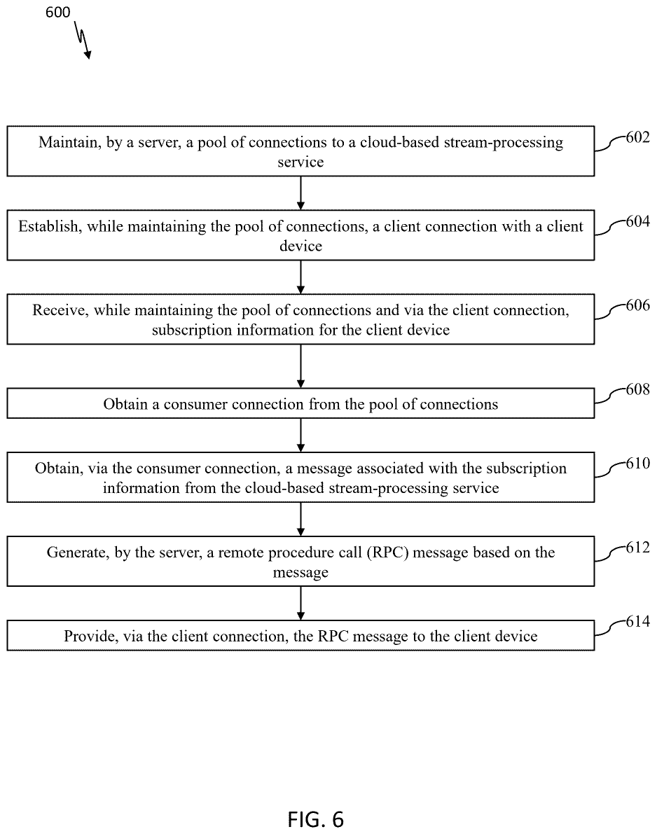

FIG. 6 illustrates a flow diagram of an example process that may be performed by a proxy service for event streaming consumers, in accordance with implementations of the subject technology. For explanatory purposes, the process 600 is primarily described herein with reference to the server 109, the server 113, and the cloud-based services 111 of FIGS. 1A-5. However, the process 600 is not limited to the server 109, the server 113, and the cloud-based services 111 of FIGS. 1A-5, and one or more blocks (or operations) of the process 600 may be performed by one or more other components of other suitable moveable apparatuses, devices, or systems. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, a server (e.g., a server that provides a proxy service, such as server 113) may maintain a pool of connections (e.g., five connections, seven connections, ten connections, or more than ten connections) to a cloud-based stream-processing service (e.g., a cloud-based service 111). The connections may be authenticated connections that allow secure communications over the connections, without additional individual authentication operations for each communication.

At block 604, the server may establish, while maintaining the pool of connections, a client connection with a client device (e.g., a consumer device 115). In some use cases, the client device may be associated with a fleet manager for a fleet of vehicles (e.g., vehicles 100). The client connection may be an authenticated connection that allows secure communications with the client device, without additional individual authentication operations for each communication.

At block 606, while maintaining the pool of connections and via the client connection, the server may obtain subscription information for the client device. For example, the subscription information may include a topic (e.g., a topic to which the client device requests to subscribe). As another example, the subscription information may include a request to automatically acknowledge messages. As another example, the subscription information may include a request to explicitly acknowledge messages.

At block 608, the server may obtain (e.g., fetch) a consumer connection from the pool of connections. The obtained consumer connection may be (e.g., temporarily) associated with the client device.

At block 610, the server may obtain, via the consumer connection, a message (e.g., message 300) associated with the subscription information from the cloud-based stream-processing service. For example, the message may be associated with the topic (e.g., the message may have been previously published to the topic at the cloud-based stream-processing service). In some use cases, the message may include information associated with at least one vehicle of the fleet of vehicles.

At block 612, the server may generate a remote procedure call (RPC) message (e.g., RPC message 302) based on the message. For example, generating the RPC message may include serializing the message, and/or otherwise modifying the message to conform to an RPC protocol. At block 614, the server may provide, via the client connection, the RPC message to the client device.

In one or more implementations, the subscription information also includes an additional topic (e.g., the client device may request to subscribe to multiple topics), and the process 600 also includes obtaining, via the consumer connection (e.g., or another consumer connection obtained from the pool), an additional message associated with the additional topic from the cloud-based stream-processing service; generating, by the server, an additional RPC message based on the additional message; and providing, via the client connection, the additional RPC message to the client device.

In one or more implementations, the subscription information includes a request to receive messages at least once, and the process 600 also includes redelivering the RPC message responsive to an error indication from the client device. In one or more implementations, the process 600 may also include, by the server: identifying a communication error, and providing an indicator of the communication error to the client device.

In one or more implementations, the process 600 may also include performing, by the server and prior to maintaining the pool of connections, an authentication operation with the cloud-based stream-processing service. The server may establish the pool of connections upon completion of the authentication operation. The server may perform, prior to establishing the client connection, an additional authentication operation with the client device. Obtaining the message associated with the subscription information from the cloud-based stream-processing service may include obtaining the message without performing a further additional authentication operation for the message or the RPC message. In one or more use cases, the server may receive a cancel request from the client device, and (e.g., responsive to the cancel request) return the consumer connection to the pool of connections maintained by the server.

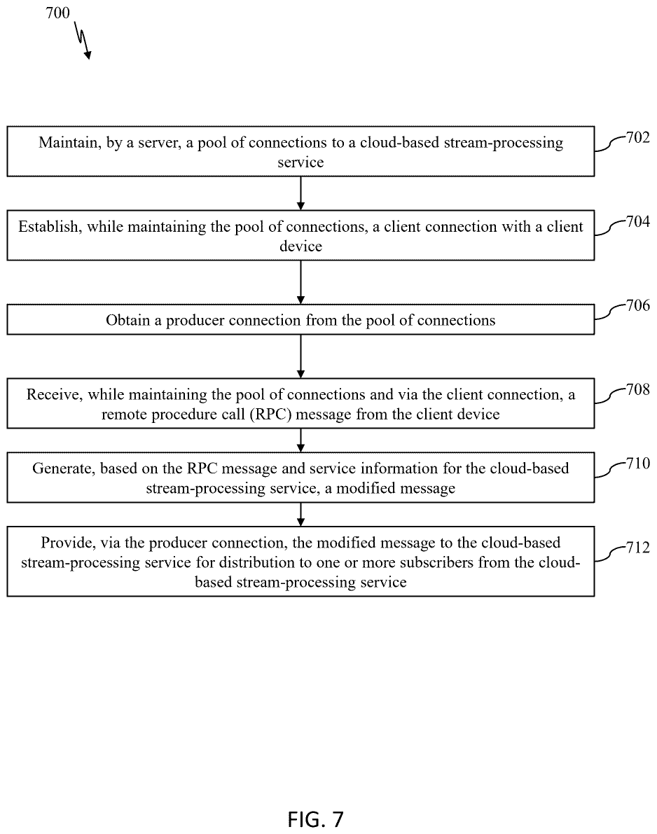

FIG. 7 illustrates a flow diagram of an example process that may be performed by a proxy service for event streaming producers, in accordance with implementations of the subject technology. For explanatory purposes, the process 700 is primarily described herein with reference to the server 109, the server 113, and the cloud-based services 111 of FIGS. 1A-5. However, the process 700 is not limited to the server 109, the server 113, and the cloud-based services 111 of FIGS. 1A-5, and one or more blocks (or operations) of the process 700 may be performed by one or more other components of other suitable moveable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, a server (e.g., a server of a proxy service, such as the server 113) may maintain a pool of connections (e.g., five connections, seven connections, ten connections, or more than ten connections) to a cloud-based stream-processing service (e.g., a cloud-based service 111). For example, the server may, prior to maintaining the pool of connections, perform an authentication operation (e.g., and/or an authorization operation) with the cloud-based stream-processing service, and establish the pool of connections upon completion of the authentication operation (e.g., and/or the authorization operation).

At block 704, the server may establish, while maintaining the pool of connections, a client connection with a client device (e.g., a publisher device or producer device, such as the server 109). The server may perform an additional authentication operation with the client device.

At block 706, the server obtains (e.g., fetch or check out) a producer connection from the pool of connections. Obtaining the producer connection may include (e.g., temporarily) associating one of the connections from the pool of connections with the client device.

At block 708, the server may receive, while maintaining the pool of connections and via the client connection, a remote procedure call (RPC) message (e.g., a message 200) from the client device. In one or more use cases, the RPC message may be associated with at least one vehicle (e.g., a vehicle 100 or a group or fleet of vehicles 100). For example, the RPC message may include vehicle data for one or more components of one or more vehicles, such as the vehicle 100 of FIG. 1A or 1B.

At block 710, the server may generate, based on the RPC message and service information for the cloud-based stream-processing service, a modified message (e.g., a message 202). For example, the service information may include protocol information (e.g., message format and/or type information for messages to and/or from the cloud-based stream-processing service) for communication with the cloud-based stream-processing service.

At block 712, the server may provide, via the producer connection, the modified message to the cloud-based stream-processing service for distribution to one or more subscribers from the cloud-based stream-processing service. For example, the server may provide the modified message to the cloud-based stream-processing service by writing the modified message and a header map (e.g., a header map generated by the server based on the RPC message received from the client device) to a partition of the cloud-based stream-processing service, the partition corresponding to a topic indicated in the RPC message. For example, the server may generate the header map responsive to receiving the RPC message (e.g., and using information received within the RPC message). The server may generate the modified message, at least in part, by deserializing the RPC message.

In one or more use cases, the server may also receive, while maintaining the pool of connections and via the client connection, an additional RPC message from the client device. The server may write an additional modified message and an additional header map to another partition of the cloud-based stream-processing service, the other partition corresponding to another topic indicated in the additional RPC message. For example, the client device may request to publish messages to multiple topics and/or multiple partitions at the cloud-based service 111.

The server may provide the modified message to the cloud-based stream-processing service without performing an authentication operation for the message or the modified message (e.g., without performing any additional authentication and/or authorization operations for messages between the client device and the cloud-based stream-processing service after establishing the pool of connections and the client connection, and/or without authenticating the client to the cloud-based stream-processing service).

In one or more use cases, the server may receive a cancel request from the client device, and (e.g., responsive to the cancel request) return the producer connection to the pool of connections maintained by the server. In one or more use cases, the server may also establish, while maintaining the pool of connections, an additional client connection with an additional client device (e.g., a consumer device 115). The server may also receive, from the cloud-based stream-processing service, an additional message (e.g., a message 300). The server may convert the additional message from to an additional RPC message (e.g., an RPC message 302) using the service information. The server may also provide the additional RPC message to the additional client device via the client additional connection.

Highly distributed event streaming platforms often run in cloud environments within logical networking boundaries (e.g., Virtual Private Cloud (VPC) and private subnets) with restricted access (e.g., firewalled CIDRs). In some cases, the actual service runs on internal subnets and maps to client subnets for user access (e.g., via client SASL/SCRAM or plaintext authentication modes). This setup prevents external trusted consumers from accessing such services (e.g., due to connectivity), consuming messages (e.g., reading from topics), or producing messages (e.g., writing to topics). Internal trusted consumers or producers for these highly distributed event streaming platforms typically use RAFT or Zookeeper client endpoints and can connect to topic partitions/shards. Such internal (e.g., fat) clients can automatically recover from failures if leaders are moved or brokers are lost. However, for external consumers that cannot use such resilient consensus (aka gossip) protocol based access mechanisms, aspects of the subject technology may provide a fault-tolerant pattern that allows access to topic streams, produce or consume using a standard interface, and ensures at least once message delivery semantics. Aspects of the subject technology provide patterns for how external clients can achieve the benefits discussed herein of an RPC-based proxy. Although Kafka is referred to herein in some examples, the mechanisms provided by the server 113 as described herein can be adopted for any other event streaming services.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method, comprising:
maintaining, by a server, a pool of connections to a cloud-based stream-processing service;
establishing, while maintaining the pool of connections, a client connection with a client device;
receiving, while maintaining the pool of connections and via the client connection, subscription information for the client device;
obtaining a consumer connection from the pool of connections;
obtaining, via the consumer connection, a message associated with the subscription information from the cloud-based stream-processing service;
generating, by the server, a remote procedure call (RPC) message based on the message; and
providing, via the client connection, the RPC message to the client device.

2. The method of claim 1, wherein the subscription information comprises a topic, and wherein the message is associated with the topic.

3. The method of claim 1, wherein the subscription information further comprises an additional topic, and wherein the method further comprises:
obtaining, via the consumer connection, an additional message associated with the additional topic from the cloud-based stream-processing service;
generating, by the server, an additional RPC message based on the additional message; and
providing, via the client connection, the additional RPC message to the client device.

4. The method of claim 1, wherein the subscription information comprises a request to receive messages at least once, and wherein the method further comprises redelivering the RPC message responsive to an error indication from the client device.

5. The method of claim 1, further comprising, by the server:
identifying a communication error; and
providing an indicator of the communication error to the client device.

6. The method of claim 1, wherein the subscription information includes a request to automatically acknowledge messages.

7. The method of claim 1, wherein the subscription information includes a request to explicitly acknowledge messages.

8. The method of claim 1, further comprising:
performing, by the server and prior to maintaining the pool of connections, performing an authentication operation with the cloud-based stream-processing service;
establishing, by the server, the pool of connections upon completion of the authentication operation; and
performing, by the server and prior to establishing the client connection, an additional authentication operation with the client device,
wherein obtaining the message associated with the subscription information from the cloud-based stream-processing service comprises obtaining the message without performing a further additional authentication operation for the message or the RPC message.

9. The method of claim 1, wherein the client device is associated with a fleet manager for a fleet of vehicles, and wherein the message comprises information associated with at least one vehicle of the fleet of vehicles.

10. A server, configured to:
maintain a pool of connections to a cloud-based stream-processing service;
establish, while maintaining the pool of connections, a client connection with a client device;
obtain a producer connection from the pool of connections;
receive, while maintaining the pool of connections and via the client connection, a remote procedure call (RPC) message from the client device;
generate, based on the RPC message and service information for the cloud-based stream-processing service, a modified message; and
provide, via the producer connection, the modified message to the cloud-based stream-processing service for distribution to one or more subscribers from the cloud-based stream-processing service.

11. The server of claim 10, wherein the server is configured to, prior to maintaining the pool of connections, perform an authentication operation with the cloud-based stream-processing service, and establish the pool of connections upon completion of the authentication operation.

12. The server of claim 11, wherein the server is configured to perform an additional authentication operation with the client device.

13. The server of claim 12, wherein the server is configured to provide the modified message to the cloud-based stream-processing service without performing an authentication operation for the message or the modified message.

14. The server of claim 10, wherein the service information comprises protocol information for communication with the cloud-based stream-processing service.

15. The server of claim 10, wherein the server is configured to provide the modified message to the cloud-based stream-processing service by writing the modified message and a header map to a partition of the cloud-based stream-processing service, the partition corresponding to a topic indicated in the RPC message.

16. The server of claim 15, wherein the server is further configured to:
receive, while maintaining the pool of connections and via the client connection, an additional RPC message from the client device; and
write an additional modified message and an additional header map to another partition of the cloud-based stream-processing service, the other partition corresponding to another topic indicated in the additional RPC message.

17. The server of claim 15, wherein the server is configured to generate the header map responsive to receiving the RPC message.

18. The server of claim 10, wherein the server is configured to generate the modified message at least in part by deserializing the RPC message.

19. The server of claim 10, wherein the server is further configured to:
receive a cancel request from the client device; and
return the producer connection to the pool of connection maintained by the server.

20. The server of claim 10, wherein the server is further configured to:
establish, while maintaining the pool of connections, an additional client connection with an additional client device;
receive, from the cloud-based stream-processing service, an additional message;
convert the additional message from to an additional RPC message using the service information; and
provide the additional RPC message to the additional client device via the client additional connection.

21. The server of claim 10, wherein the RPC message is associated with at least one vehicle.

22. A proxy server, configured to:
maintain a pool of connections to a cloud-based stream-processing service;
establish, while maintaining the pool of connections, a client connection with a client device;
receive, while maintaining the pool of connections and via the client connection, subscription information for the client device;
obtain a consumer connection from the pool of connections;
obtain, via the consumer connection, a message associated with the subscription information from the cloud-based stream-processing service;
generate a remote procedure call (RPC) message based on the message; and
provide, via the client connection, the RPC message to the client device.
